(19) United States
(12) Patent Application Publication
(10) Pub. No.: US 2022/0414583 A1
(43) Pub. Date: Dec. 29, 2022

(54) ENTITY MATCHING FOR SOFTWARE DEVELOPMENT

(71) Applicant: Acumen Labs LTD, Tel-Aviv (IL)

(72) Inventors: Idan AMIT, Ramat Gan (IL); Itamar MOLEA, Tel Aviv (IL)

(73) Assignee: Acumen Labs LTD, Tel-Aviv (IL)

(21) Appl. No.: 17/359,588

(22) Filed: Jun. 27, 2021

(51) Int. Cl. G06Q 10/06; G06F 8/77; G06N 20/00; G06N 5/04

(52) U.S. Cl. CPC G06Q 10/063118; G06F 8/77; G06N 20/00; G06N 5/04

(57) ABSTRACT

A method for managing code development comprises: accessing at least one software code project on one or more software development platforms; computing a plurality of signature values, each signature value computed for one of a plurality of operators of the at least one software code project according to a plurality of entries associated with the operator in one of the one or more software development platforms and indicative of a plurality of software development characteristics of the operator; identifying a set of matches in the plurality of operators, each match identified between at least two of the plurality of operators according to the plurality of signature values; and providing the set of matches to at least one management software object for the purpose of performing at least one management task of the at least one code project.

### FIELD AND BACKGROUND OF THE INVENTION

Some embodiments described in the present disclosure relate to entity matching and, more specifically, but not exclusively, to entity matching between software development platforms.

The term “entity matching” refers to the problem of identifying whether two or more entity descriptors refer to a common real-world object. Entity matching is also referred to as “identity matching” and the terms are used herewithin interchangeably.

Entity matching is needed in a variety of domains. For example, in the field of computer vision, there may be a need to identify that one car identified in one image and another car identified in another image are in fact the same car.

As our world is becoming increasingly digitized, there is an increasing need to identify whether individuals associated with a variety of digital records are the same individual. For example, there could be a need to identify whether authors of multiple papers retrieved from multiple databases are the same real-world person. A commercial application may benefit from identifying whether entities on several social media platforms are the same real-world person.

As used herewithin, the term “code development” refers to activities dedicated to creating, designing, deploying and supporting software applications. Such activities include a variety of steps from conception of a desired application or desired product to a manifestation of the desired application or product, including, but not limited to, designing the software application or product, writing the source code and maintaining it, i.e. modifying the source code, testing the software application or product, and deploying the software application or product. It is common practice for code development to involve a team of operators, each having one or more roles in the code development. For example, development of a software application may involve a group of developers who write and modify code, a group of testers who perform testing activities and one or more managers who track progress of various development activities. An operator may have more than one role. An operator may be a computerized agent, for example an automated testing agent.

There exist a variety of digital platforms for managing software development, henceforth referred to as software development platforms. Some software development platforms are version control systems, also known as code management systems, used to manage source code. Some other examples of a software development platform are a task management system and a defect tracking system. As used herewithin, the term “software code project” refers to a collection of code development activities of a software application. An entry in a software development platform is typically associated with a software code project and with one or more operators of the software code project. For example, an entry in a code management system documenting a modification to a source file of a software code project is typically associated with a developer who modified the source file. In another example, a defect entry in a defect tracking system could be associated with a testing operator who reported the defect and additionally or alternatively with a developer assigned to correct the defect.

There exist integrated development management systems where several aspects of code development are managed together, and entities are shared between various parts of the development management system. In such a system, a developer entity associated with a source code entry may be additionally associated with a development task. However, there exist software code projects that use a plurality of development platforms that do not share entities. For example, it is possible for a software development project to manage tasks using Altassian Jira, manage source code using hosting such as GitHub and track defects using Edgewall Software Trac. In such software code projects, each real-life operator of the software code project has a distinct entity in each of the plurality of development platforms.

To manage code development, there is a need to associate entities of one software development platform with entities of another software development platform, for example associate a developer entity in a code management system with another developer entity in a task management system.

The problem of identifying a plurality of instances of the same entity is known also as record linkage and the merge-purge problem. An overview of the merge-purge problem is described for example in works by Winkler. The record linkage problem was discussed for example by Newcombe et al.

Within record linkage, name matching has an important role, since name similarity is very informative for similarity between instances (instance similarity). Name matching was used by Newcombe et al. in their seminal work on record linkage. However, there are many ways to match names and no technique seems to dominate the rest, as shown for example by Christen. The difficulty in this field comes from the variations in names. While it is rare, different people might have the same name. On the other hand, a name might be misspelled, have several possible spellings, be replaced by a nickname or may change (e.g., due to marriage). It should be noted that name matching is not limited to human names. There exist works on organization name matching on bibliographic data and products. Such works are relevant and apply close methods. The difference is in the equivalence rules, for example the omission of “LCC”, which hold yet less useful information for human names.

Comparison of textual name matching algorithms does not identify a dominating algorithm. It should be noted that such comparisons highly depend on the evaluation data set. The suitable metric, e.g. the weighting of false positives and false negatives, is usually use case dependent and cannot be captured in general comparisons.

While common distance metrics are handcrafted, indifferent to the used data set, in some works distance metrics are combined by using them as input to machine learning.

Myriad distance metrics for names have been suggested. Levenshtein is a distance metric for any strings, counting the number of changes differing them. The Guth and Jaro-Winkler are other distance metrics based on text similarity alternatives. The Soundex algorithm, producing the same digest to names similarly sounding the Metaphone and Phonex are algorithms that represent phonetic similarity. Bhattacharya investigates clustering of entities given the matching.

The complexity of identifying entity pairs is O(n²), where n denotes the amount of entities in which pairs are matched, and prior work tries to reduce this complexity.

### SUMMARY OF THE INVENTION

Some embodiments of the present disclosure describe a system and a method for matching operators of one or more software code projects in one or more software development platforms, based on one or more signature values indicative of a plurality of software development characteristics of an operator.

The foregoing and other objects are achieved by the features of the independent claims. Further implementation forms are apparent from the dependent claims, the description and the figures.

According to a first aspect of the invention, a method for managing code development comprises: accessing at least one software code project on one or more software development platforms; computing a plurality of signature values, each signature value computed for one of a plurality of operators of the at least one software code project according to a plurality of entries associated with the operator in one of the one or more software development platforms and indicative of a plurality of software development characteristics of the operator; identifying a set of matches in the plurality of operators, each match identified between at least two of the plurality of operators according to the plurality of signature values; and providing the set of matches to at least one management software object for the purpose of performing at least one management task of the at least one code project. Using a plurality of signature values, each computed according to a plurality of software development characteristics of an operator, increases accuracy of identifying the set of matches, and thus increases usability of a code development management system using the set of matches.

According to a second aspect of the invention, a system for managing code development comprises at least one hardware processor adapter for: accessing at least one software code project on one or more software development platforms; computing a plurality of signature values, each signature value computed for one of a plurality of operators of the at least one software code project according to a plurality of entries associated with the operator in one of the one or more software development platforms and indicative of a plurality of software development characteristics of the operator; identifying a set of matches in the plurality of operators, each match identified between at least two of the plurality of operators according to the plurality of signature values; and providing the set of matches to at least one management software object for the purpose of performing at least one management task of the at least one code project.

According to a third aspect of the invention, a software program product for managing code development comprises: a non-transitory computer readable storage medium; first program instructions for: accessing at least one software code project on one or more software development platforms; second program instructions for: computing a plurality of signature values, each signature value computed for one of a plurality of operators of the at least one software code project according to a plurality of entries associated with the operator in one of the one or more software development platforms and indicative of a plurality of software development characteristics of the operator; third program instructions for: identifying a set of matches in the plurality of operators, each match identified between at least two of the plurality of operators according to the plurality of signature values; and fourth program instructions for: providing the at least one match to at least one management software object for the purpose of performing at least one management task of the at least one code project. The first, second, third and fourth program instructions are executed by at least one computerized processor from the non-transitory computer readable storage medium.

In an implementation form of the first and second aspects, at least one of the plurality of operators is a developer, and the respective signature value computed for the developer comprises a plurality of code style statistical values, each indicative of a characteristic of code development style of the developer. Optionally, at least one of the plurality of code style statistical values is selected from the group of code style statistical values consisting of: an amount of characters in a committed code segment, an area identifier indicative of a functional area of a plurality of functional areas of a software code project, a file identifier indicative of a file of the software code project, and an amount of coding errors. Optionally, for at least one other operator of the plurality of operators the respective signature value computed for the other operator comprises one or more personal detail values thereof. Optionally, at least one of the one or more personal detail values is selected from the group of personal detail values consisting of: a first name, a last name, a nickname, a date of birth, an electronic mail address, a username, a home address, a commit date, an employment date, a roll identifier, and an image. Optionally, for at least one yet other operator of the plurality of operators the respective signature value computed for the yet other operator comprises a plurality of text style signature values each computed according to a plurality of textual entries added to the one or more software development platforms thereby. Using one or more of a code style statistical value, a personal detail value and a text style signature value when computing a signature value of an operator increases accuracy of the signature value, and thus increases accuracy of a match computed using the signature value. Optionally, the method further comprises computing a graph, indicative of a plurality of matches between the plurality of operators and identifying the set of matches is further according to the graph. Using a graph indicative of a plurality of matches between the plurality of operators increases accuracy of the set of matches.

In a further implementation form of the first and second aspects, each operator of the plurality of operators is described by one of a plurality of entity descriptors. Optionally, the method further comprises adding to at least one of the plurality of entity descriptors at least one additional personal detail value retrieved from at least one additional platform and the respective signature value computed for the respective operator described by the at least one entity descriptor is further according to the at least one additional personal detail value. Optionally, the method further comprises computing at least one feature value, each indicative of a characteristic of the plurality of entity descriptors and computed according to the plurality of entity descriptors and identifying the set of matches is further according to the at least one feature value. Optionally, computing the at least one feature value comprises at least one of: identifying at least one dissociated pair of operators of the plurality of operators according to the plurality of signature values; computing a plurality of nickname associations using the plurality of entity descriptors; and computing a distance between at least two names, each described by one of the plurality of entity descriptors. Enhancing an entity descriptor by adding to the entity descriptor at least one additional personal detail value retrieved from at least one additional platform and additionally or alternatively at least one feature value indicative of a characteristic of the plurality of entity descriptors increases accuracy of a signature value computed for an operator, and thus increases accuracy of a match computed using the signature value

In a further implementation form of the first and second aspects, at least one of the one or more software development platforms is selected from a group of software development platforms consisting of: a task management system, a code management system, and a defect tracking system. Optionally, accessing said at least one software code project on said one or more software development platforms is via at least one digital communication network interface connected to said at least one hardware processor.

In a further implementation form of the first and second aspects, identifying the set of matches comprises: providing a signature value of a first operator and another signature value of a second operator to at least one machine learning model trained to classify a match between at least two operators according to at least two signature values; and classifying the first operator and the second operator as a pair of equivalent operators by the at least one machine learning model. Optionally, each operator of the plurality of operators is described by one of a plurality of entity descriptors. Optionally, training the at least one machine learning model comprises: computing at least one training feature value, each indicative of a characteristic of the plurality of entity descriptors and computed according to the plurality of entity descriptors; and providing to the machine learning model the at least one training feature value with the plurality of entity descriptors. Optionally, computing the at least one training feature value comprises at least one of: identifying at least one dissociated pair of operators of the plurality of operators according to the plurality of signature values; computing a plurality of nickname associations using the plurality of entity descriptors; and computing a distance between at least two names, each described by one of the plurality of entity descriptors. Training a machine learning model using one or more training feature values computed as described above increases accuracy of the machine learning model, increasing accuracy of a match classified thereby and thus increasing accuracy of the set of matches.

In a further implementation form of the first and second aspects, the at least one management task is selected from a group of management tasks consisting of: identifying a code area, identifying a developer workload, and identifying a late development task.

In a further implementation form of the first and second aspects, the operator is a human operator or a computerized agent.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which embodiments. Although methods and materials similar or equivalent to those described herein can be used in the practice or testing of embodiments, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments are herein described, by way of example only, with reference to the accompanying drawings. With specific reference now to the drawings in detail, it is stressed that the particulars shown are by way of example and for purposes of illustrative discussion of embodiments. In this regard, the description taken with the drawings makes apparent to those skilled in the art how embodiments may be practiced.

In the drawings:

FIG. 1 is a schematic block diagram of an exemplary system, according to some embodiments;

FIG. 2 is a schematic block diagram illustrating an exemplary matching of a plurality of operators, according to some embodiments;

FIG. 3 is a flowchart schematically representing an optional flow of operations for matching, according to some embodiments;

FIG. 4 is a flowchart schematically representing an optional flow of operations for computing a feature value, according to some embodiments; and

FIG. 5 is a flowchart schematically representing an optional flow of operations for training, according to some embodiments.

### DESCRIPTION OF SPECIFIC EMBODIMENTS OF THE INVENTION

In code development management, it is crucial for a manager to have a clear impression of the status of development. A manager may need to track development progress, possibly in comparison to a development plan, understand how many outstanding defects exist, identify a functional area of a software code project that requires attention, and identify resource bottlenecks, for example a late development task or a developer's workload. Software development platforms are used to track tasks and activity reports. Useful management information may include combining entries from more than one software development platform. For example, when task management is done on one platform and defect reporting is done on another platform, identifying that a defect report is not handled because a developer assigned to the defect is assigned to another development task requires information from the two platforms. Another example is identifying an area of code prone to errors, according to an amount defect reports associated with the area of code, and identifying insufficient review tasks for the error prone area of code.

However, as software code projects become more complex, comprising increasing amounts of tasks and activity reports, it is becoming increasingly harder for a manager to glean useful information from the multitude of entries in the software development platforms. Performing such management tasks automatically requires an ability to associate entries on one software development platform with other entries on another software development platform. This association is also known as “record linkage”. To associate entries of a plurality of software development platforms there is a need to identify one or more matches between representations of operators on the plurality of software development platforms.

Some existing methods for associating operators of more than one software development platforms rely on textual name matching. However, name based matching is not always accurate, for example due to one or more causes such as partial name information and alternative spelling. Another problem with name based matching is that an amount of pairs of name lengths tends to be high and therefore estimation of statistics there is noisy. One possible solution is by smoothing statistics using values of neighboring values, for example as described in U.S. Pat. No. 10,574,681 February/2020, Meshi et al., Detection of known and unknown malicious domains.

On some platforms, an operator of a software code project may have a username that is a nickname. In addition, a name may be misspelled, have more than one spelling or may change (for example due to marriage). It is also possible for two operators to have the same name. In addition, a real-life person may have more than one operator entity on a software development platform, for example have multiple user accounts on a software development platform.

For brevity, unless otherwise noted the term “platform” is used to mean “software development platform” and the terms are used interchangeably. In addition, for brevity the term “project” is used to mean “software code project” and the terms are used interchangeably.

In the domain of software code development, it is possible to characterize an operator according to one or more software development characteristics. A software development characteristic may be a characteristic of an operator as an individual. For example, a developer may have a field of expertise, such that the developer typically develops code pertaining to their field of expertise. For example, one developer may be more likely to develop code for operating system kernel functionality while another developer may be more likely to develop code for graphical user interface functionality. Some developers have a characteristic code development style, for example a tendency to use long variable names as opposed to using short variable names, or a tendency to use spaces between mathematical operators as opposed to not using spaces. A tester may be assigned to one functional area, for example user-interface, of a project while another tester may be assigned to another functional area of the project, for example network communications.

A software development characteristic may be a characteristic of an operator within a project in the domain of software development. For example, in the domain of software development it is assumed that an operator adding a code modification to a code management system is a developer and not a tester. Similarly, a product manager is not expected to contribute to a code management system. In another example, in the domain of software development there may be an assumption of a closed set of operators in a project, such that an operator on one platform, for example a code management system, may have a matching operator on another platform, for example a task management system. Such a closed world assumption is described in Reiter R., On closed world data bases., Readings in artificial intelligence, pages 119-140. Elsevier, 1981. Combining labeling functions with knowledge about common nicknames allows matching between operators. For example, a first operator may be identified on a first platform as “CodeWarrior” and have an electronic mail address of “david@ourCompany.com”. On a second platform, a second operator may be identified as “Dave” without an electronic mail address. Knowing that “Dave” is a common nickname of “David” allows matching the second operator on the second platform with the first operator on the first platform. Further in this example, within the same software project it may be safe to deduce that a third operator with the nickname “CodeWarrior” on a third platform is the same second operator “Dave” of the second platform. Yet another example of a characteristic of an operator within a project is assuming uniqueness in time of a username, which may be used together with activity dates to distinguish between two operators having a similar username but distinctly separate activity periods.

To increase accuracy of identifying a match between two or more operators, the present disclosure, in some embodiments described herewithin, proposes using a signature value indicative of a plurality of software development characteristics of an operator to identify a match. The present disclosure proposes, in some embodiments, matching operators according to signature values computed for each of the operators.

In such embodiments, a set of matches is identified in a plurality of operators according to a plurality of signature values, where each match is identified between at least two of the plurality of operators according to the plurality of signature values. Optionally, each of the plurality of signature values is computed for one of the plurality of operators and is indicative of a plurality of software development characteristics of the operator. Optionally, each of the plurality of signature values is computed according to a plurality of entries associated with the operator in one of the one or more platforms. Optionally, a signature value is computed according to a plurality of entries associated with the operator in more than one platform. In one example, a signature value is computed according to a plurality of code modification entries associated with an identified developer. Optionally, the plurality of entries are related to more than one project. Optionally, the plurality of entries is retrieved from more than one platform. In another example, another signature value is computed according to a plurality of response entries in a defect tracking system associated with another developer. Using a signature computed according to the plurality of software development characteristics increases accuracy of identifying the set of matches, and thus increases usability of a code development management system using the set of matches.

When the operator is a developer, a respective signature value computed for the developer may comprise a plurality of code style statistical values, each indicative of a characteristic of code development style of the developer. An amount of characters in a committed code segment is one possible example of a code style statistical value. Other possible examples of a code style statistical value include, but are not limited to, an area identifier indicative of a functional area of a plurality of functional areas of a project, a file identifier indicative of a file of the project, and an amount of coding errors. Optionally, a signature value comprises one or more personal details of the respective operator for which the signature value is computed. For example, the signature value may comprise one or more name characteristics, for example one or more of a first name, a last name, a full name and a nickname. Optionally, the signature value comprises one or more electronic mail address characteristics, for example one or more of a full electronic mail address, a user name, and a tokenized electronic mail address. A non-limiting list of other examples of personal details includes a username on a platform, a roll, a date of name change, a membership in a known group, for example employees or external contractors, an image, and a date. Some examples of a date are an activity date and a date of employment. Optionally, the signature value comprises one or more text style signature values. A text style signature value may be computed according to a plurality of textual entries added to the one or more platforms by the respective operator for which the signature is computed.

In addition, in some embodiments the present disclosure proposes enhancing information describing an operator with one or more additional personal detail values retrieved from one or more additional platforms. For example, an operator may be associated with an entry on a social media platform, for example Linkedin or Stackoverflow. Information describing the operator may be enhanced with one or more additional personal detail values retrieved from linked in, for example an image, a nickname, a username and a date of employment. Enhancing information describing an operator with one or more additional personal detail values retrieved from the one or more additional platforms increases accuracy of the set of matches and thus increases usability of a code management system using the set of matches.

In addition, the present disclosure proposes in some embodiments enhancing information describing an operator with one or more computed features, where a computed feature is computed according to information describing the plurality of operators. A computed feature may describe one operator, for example a name related feature such as breaking a name into components, canonization etc. A computed feature may describe a programming characteristic of an operator that is a developer, for example effective code refactors associated with the operator, for example using a method as described in Amit I. and Feitelson D. G., Which refactoring reduces bug rate?, Proceedings of the Fifteenth International Conference on Predictive Models and Data Analytics in Software Engineering, PROMISE'19, page 12-15, New York, N.Y., USA, 2019. Association for Computing Machinery. Another example of a programming characteristic of a developer is described in Amit I., Matherly J., Hewlett W., Xu Z., Meshi Y., and Weinberger Y., Machine learning in cyber-security—problems, challenges and data sets, 2019.

Optionally, a computed feature describes a relationship between operators, for example a distance between names of two operators, computed according to a name distance function. One example of a name distance function was described by Levenshtein. Some other distance functions based on text similarity are described by Hernandez and by Dressler. Some distance functions based on phonetic similarity are described by Odell, by Binstock, and by Lait.

Optionally, a computed feature is indicative of similarity in activity, for example by combining prior activity of one operator with current activity of another operator in order to identify a change.

Optionally, a computed feature is indicative of a disassociation between two operators. A disassociation between two operators prevents a false association between the two operators, for example two operators having a common name however identified as separate real life entities, for example according to activity dates.

In addition, in some embodiments the present disclosure proposes using one or more machine learning models trained to classify a match between two or more operators according to two or more signature values.

Data sets available for training a machine learning model to classify a match between two or more operators tend to be small and frequently are mislabeled, resulting in low accuracy of a machine learning model trained using such data sets. To increase accuracy of a machine learning model, in some embodiments the present disclosure proposes that training the one or more machine learning models comprises using one or more entity descriptors, each describing one of the plurality of operators, for example in a plurality of semi-supervised training iterations. Optionally, some of the one or more entity descriptors are labeled by a human annotator, optionally after at least one first set of matches is identified. Labeling the one or more entity descriptors after at least one first set of matches is identified allows a human annotator to focus only on harder to judge cases. Using the one or more entity descriptors, optionally labeled by a human annotator, to train the one or more machine learning models increases accuracy of the machine learning model when used for identifying another set of matches between another plurality of operators of the one or more software platforms as the one or more entity descriptors are characteristic of the environment in which the one or more software platforms are used.

Optionally, training the one or more machine learning models further comprises providing at least one of the one or more computed features to the one or more machine learning models. Training a machine learning model using one or more computed features increases accuracy of an output of the trained machine learning model, thus increases accuracy of a match computed by the trained machine learning model.

According to some embodiments described herewithin, a linkage graph is computed, indicative of a plurality of matches between the plurality of operators. The graph may represent each of the plurality of operators with a node of the graph, where an edge between two nodes, each representing an operator, indicates a match between the respective two operators represented by the two nodes. Optionally, the graph further comprises a sub-graph for each of the plurality of platforms. Optionally, a node representing an operator is connected by an edge to a sub-graph representing a platform when the operator is identified in the platform.

Optionally, constraints are applied to the graph, for example a node in a sub-graph may have at most one edge to a sub-graph representing a platform. Another example of a constraint is requiring that all nodes in one sub-graph have an edge connected to another node in an identified sub-graph.

Optionally, training the one or more machine learning models comprises providing the linkage graph to the one or more machine learning model. Training a machine learning model using the linkage graph increases accuracy of an output of the trained machine learning model, thus increases accuracy of a match computed by the trained machine learning model.

Before explaining at least one embodiment in detail, it is to be understood that embodiments are not necessarily limited in its application to the details of construction and the arrangement of the components and/or methods set forth in the following description and/or illustrated in the drawings and/or the Examples. Implementations described herein are capable of other embodiments or of being practiced or carried out in various ways.

Embodiments may be a system, a method, and/or a computer program product. The computer program product may include a computer readable storage medium (or media) having computer readable program instructions thereon for causing a processor to carry out aspects of the embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of embodiments may be assembler instructions, instruction-set-architecture (ISA) instructions, machine instructions, machine dependent instructions, microcode, firmware instructions, state-setting data, or either source code or object code, natively compiled or compiled just-in-time (JIT), written in any combination of one or more programming languages, including an object oriented programming language such as Smalltalk, C++, Java or the like, an interpreted programming language such as JavaScript, Python or the like, and conventional procedural programming languages, such as the “C” programming language, Fortran, or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of embodiments.

Aspects of embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

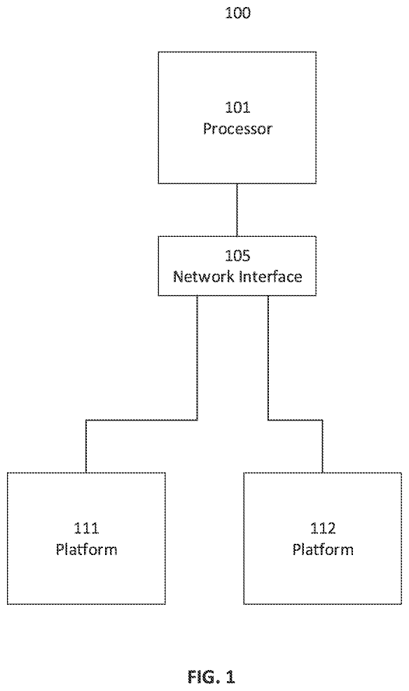

Reference is now made to FIG. 1, showing a schematic block diagram of an exemplary system 100, according to some embodiments. In such embodiments, at least one hardware processor 101 is connected to one or more software development platforms, for example including platform 111 and platform 112. An example of a software development platform is a code management system, for example Git, GitHub, IBM Rational ClearCase, Microsoft Visual SourceSafe (VSS), Concurrent Versions System (CVS), and Apache Subversion (SVN). Another example of a software development platform is a task management system, for example Altassian Jira, Trello, and JetBrains YouTrack. A software development platform may be a defect tracking system, for example Edgewall Software Trac, BugFender, and Backlog(dot)com. Optionally, each of one or more software code projects is on at least some of the one or more software development platforms. Optionally, at least one hardware processor 101 is connected to one or more digital communication network interface 105.

For brevity, henceforth the term “network interface” is used to mean “one or more digital communication network interface”. Network interface 105 is optionally connected to a local area network (LAN), for example an Ethernet network or a Wi-Fi network. Optionally, network interface 105 is connected to a wide area network (WAN), for example a cellular network or the Internet. Optionally, at least one hardware processor 101 is connected to the one or more software development platforms via network interface 105.

For brevity, henceforth the term “processing unit” is used to mean “at least one hardware processor” and the terms are used interchangeably.

When the one or more platforms are used to manage the one or more projects, i.e. the one or more projects are on the one or more platforms, a plurality of entries in the one or more platforms may be each associated with one of a plurality of operators of the one or more software code projects.

As used herewithin, the term “real-life operator” refers to a unique agent operating in a system in the real world, for example a person or a computerized agent. The term “operator” refers to an entity representing a real-life operator. A real-life operator may be represented by more than one operator in more than one platforms.

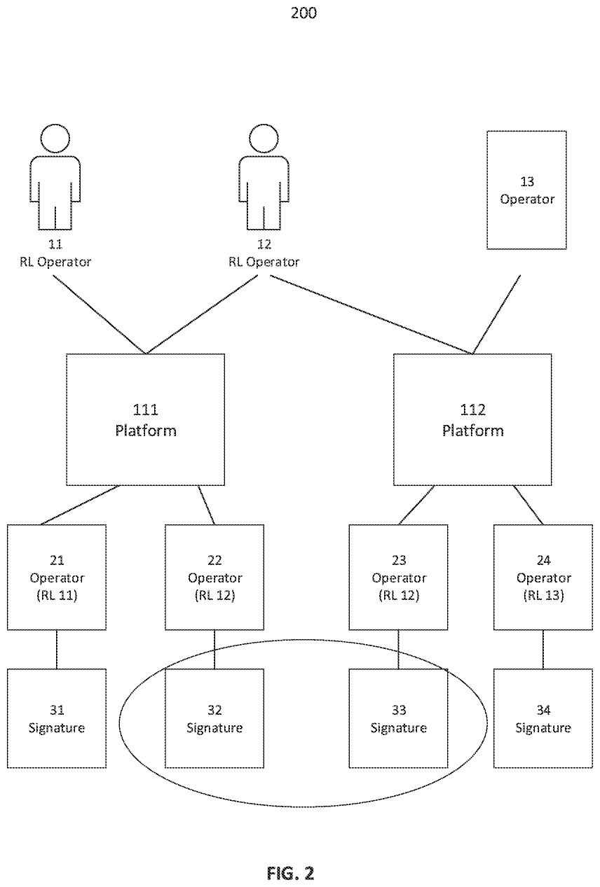

Reference is now made also to FIG. 2, showing a schematic block diagram illustrating an exemplary matching 200 of a plurality of operators, according to some embodiments. In such embodiments, a plurality of operators of the one or more software code projects comprises real-life operator 11, real-life operator 12 and real-life operator 13. One example of a possible entry is a comment in a discussion. Other examples of an entry include a code segment, metadata of a commit to a code management system, for example documenting a reason for the code commit, for example a big fix, and a work log entry. Some entries in platform 111 may be associated with real-life operator 11. In this example, real-life operator 11 is identified on platform 111 as operator 21. Similarly, in this example real-life operator 12 is identified on platform 111 as operator 22. However, in this example, real-life operator 12 is identified on platform 112 as operator 23. In addition, in this example real-life operator 13 is identified on platform 112 as operator 24. An operator may be a human operator, for example operator 21 representing real-life operator 11. Optionally, an operator is a computerized agent, for example operator 23 representing real-life operator 13. Optionally, real-life operator 13 is executed on one or more other hardware processors, not shown.

Thus, a plurality of operators of the one or more software code projects including operator 21, operator 22, operator 23 and operator 24 has two separate operators, operator 22 and operator 23 that represent a common real-life operator 12. There is a need to match between operator 22 and operator 23.

According to some embodiments disclosed herewithin, for each of the plurality of operators a signature value is computed. Thus, in this example, signature 31 is computed for operator 21, signature 32 is computed for operator 22, signature 33 is computed for operator 23, and signature 34 is computed for operator 24. According to some embodiments, a match between operator 22 and operator 23 is identified according to a match between signature 32 and signature 33.

To do so, in some embodiments disclosed herewithin system 100 implements the following optional method.

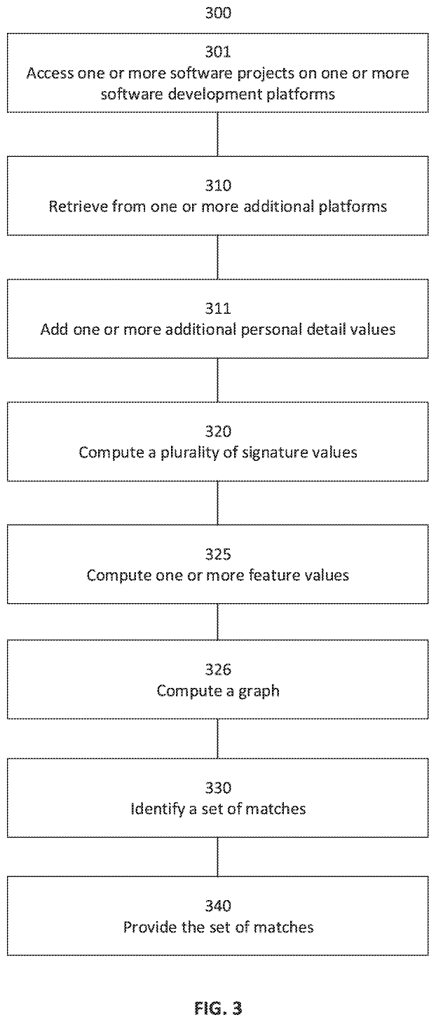

Reference is now made also to FIG. 3, showing a flowchart schematically representing an optional flow of operations 300 for matching, according to some embodiments. In such embodiments, in 301 processing unit 101 accesses one or more software development platforms, for example including platform 111 and platform 112. Optionally, processing unit 101 accesses the one or more projects on the one or more software development platforms.

In 320, processing unit 101 optionally computes a plurality of signature values, each computed for one of the plurality of operators of the one or more projects. Optionally, each signature value is computed according to a plurality of entries in one of platform 111 and platform 112, where the plurality of entries is associated with the respective operator for which the signature value is computed. For example, processing unit 101 may compute signature 31 for operator 21 according to the respective plurality of entries in platform 111 associated with operator 21. Similarly, processing unit 101 may compute signature 23 for operator 23 according to the respective plurality of entries in platform 112 associated with operator 23. Optionally, processing unit 101 retrieves at least some of the plurality of entries from platform 111 and additionally or alternatively from platform 112.

According to some embodiments, each of the plurality of signature values is indicative of a plurality of software development characteristics of the respective operator for which the signature value is computed. For example, when operator 22 is a developer, signature value 32 optionally comprises a plurality of code style statistical values, each indicative of a characteristic of code development style of the developer. Some examples of a code statistical value are an amount of characters in a committed code segment, an area identifier indicative of a functional area of a plurality of functional areas of a project, a file identifier indicative of a file of the project, and an amount of coding errors. Optionally, a code style statistical value is computed according to a plurality of entries of more than one of the one or more projects. Optionally, a code style statistical value is computed according to a plurality of entries on more than one of the one or more platforms, for example when the one or more platforms comprise more than one code management system.

Optionally, signature value 32 comprises one or more personal detail values of operator 22. Some examples of a personal detail value include a first name, a last name, a nickname, a date of birth, an electronic mail address, a username, a home address, a commit date, an employment date, for example a date of employment start and additionally or alternatively a date of employment termination, a date of a name change, and an image. Another example of a personal detail value is a role identifier, identifying an operator as one or more of a plurality of project roles. Some examples of a role include a developer, a project manager, a tester, a data scientist, and a graphic designer. A personal detail value may be any one or more electronic mail address characteristics, for example a full address, a username and a tokenized address. Optionally, a personal detail value is indicative of a membership of an operator in a known group, for example a group of company employees, a group of external employees, and a group of stakeholders in a project. Optionally, a personal detail is any date value, for example an activity date or a date of an identified event.

Optionally, signature value 32 comprises one or more text style signature values. Optionally, each of the one or more text style signature values is computed according to a plurality of textual entries added to the one or more platforms by operator 22. Some examples of a textual entry are a comment on a discussion board, for example on a fault tracking system or a task management system. Another example of a textual entry is a comment on a commit to a code management system. Some examples of a text style signature value include an amount of words in a textual entry and a language register of a textual entry.

In some embodiments, each of the plurality of operators is described by one of a plurality of entity descriptors. Optionally, computing the signature value for an operator is according to the respective entity descriptor describing the operator, and additionally or alternatively according to the plurality of entity descriptors.

In some embodiments processing unit 101 retrieves in 310 one or more additional personal detail values from one or more additional platforms. For example, processing unit 101 may retrieve a personal detail value of operator 22 from a social media platform for example Stackoverflow, Linkedin, Twitter, and Facebook. Optionally, processing unit 101 retrieves a personal detail value of operator 21 from other code management systems, for example from a public GitHub repository. An additional personal detail value may be a code segment. Other examples of an additional personal detail include a date, an image, a link to an image, and a segment of text. A date may be a date of employment by one or more companies. A personal detail value may be indicative of a skill or a profession of operator 22.

In 311, processing unit 101 optionally adds the one or more additional personal detail values to the respective entity descriptor describing operator 22. Optionally, computing signature value 31 is further according to the one or more additional personal detail values.

In 330 processing unit 101 optionally identifies a set of matches in the plurality of operators. Optionally, each match is identified between at least two of the plurality of operators according to the plurality of signature values. For example, the set of matches may include a match between operator 22 and operator 23, optionally identified according to signature value 32 and signature value 33.

When the plurality of operators is described by the plurality of entity descriptors, in 325 processing unit 101 optionally computes one or more feature values. Optionally, each feature value is computed according to the plurality of entity descriptors and is indicative of a characteristic of the plurality of entity descriptors.

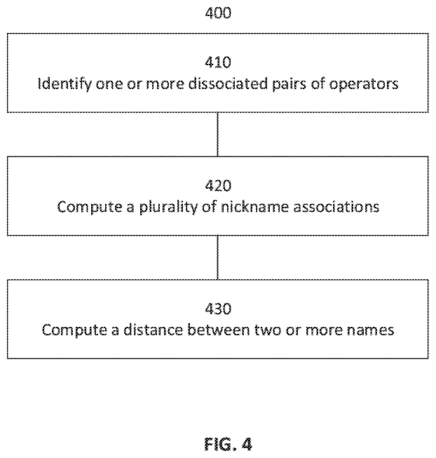

Reference is now made also to FIG. 4, showing a flowchart schematically representing an optional flow of operations 400 for computing a feature value, according to some embodiments. A feature value may be indicative of a relationship between two or more of the plurality of entity descriptors, for example in 430 processing unit 101 may compute a distance between at least two names, for example a first name described by a first entity descriptor and a second name described by a second entity descriptor. Another example of a feature value is a set similarity index, computed according to an identified set similarity metric. One example of a set similarity index is a Jaccard index. Some other examples of a set similarity metric are described by Aizawa and by Leydesdorff. A feature value may be indicative of a relationship excluding a match between two operators of the plurality of operators, for example operator 24 representing computerized agent 14 cannot be matched with operator 21 representing human operator 11. Other negative indicators include association with different functional areas of a project's plurality of functional areas, a difference between a role of a first operator and a second operator, and an association with activities at an identified time. In 410, processing unit 101 optionally identifies at least one dissociated pairs of operators in the plurality of operators, according to the plurality of signature values.

A feature value may be indicative of one of the plurality of entity descriptors, for example computed according to a name value, such as breaking a name value into a plurality of name components, computing a set representation of a name value, and a canonical representation of the name value. Other examples of a feature value include an indication of a marriage related name change, a token computed from an electronic mail address, a token to exclude from matching between two operators, and a nickname extracted from a user name or an electronic mail address. A feature value may be indicative of a behavioral characteristic of the operator, for example according to a plurality of activity entries in the respective plurality of entries associated with the operator, for example a preferred time of day of working and an identified vacation period.

In 420, processing unit 101 optionally computes a plurality of nickname associations using the plurality of entity descriptors. To do so, processing unit 101 optionally computes a plurality of name associations of a plurality of names extracted from the plurality of entity descriptors, each name associated with an electronic mail address. Optionally, processing unit 101 computes the plurality of name associations according to the respective electronic mail address associated therewith, based on an assumption that an electronic mail address uniquely identifies a user. Optionally, processing unit 101 uses the plurality of name associations to compute the plurality of nickname associations. Optionally, processing unit 101 further uses one or more data sets of known nickname associations when computing the plurality of nickname associations. Optionally, processing unit 101 computes the plurality of nickname associations using a machine learning model trained, using the one or more data sets of known nickname associations, to compute the plurality of nickname associations in response to the plurality of name associations. Using the one or more data sets of known nickname associations increases accuracy of the plurality of nickname associations, for example reducing an amount of errors due to spelling errors.

Reference is now made again to FIG. 3. Optionally, identifying the set of matches in 330 is further according to the one or more feature values computed in 325.

In some embodiments, in 326 processing unit 101 computes a graph, indicative of a plurality of matches between the plurality of operators. For example, a node in the graph may represent one of the plurality of operators. An edge between two nodes may represent a match between the two respective operators represented by the two nodes. Optionally, the edge is indicative of a condition prohibiting a match between the two respective operators.

Optionally, the graph is computed according to one or more constraints that characterize the plurality of operators. In an embodiment, the graph is organized in sub-graphs where a set of operators represented by a set of nodes of a sub-graph are associated with a common platform. For example, a set of nodes of a first sub-graph may represent a set of operators of a first platform, for example a version control system, and another set of nodes of a second sub-graph may represent another set of operators of a second platform, for example a task management system. A node may have a type according to a platform associated thereof, for example each node of a sub-graph associated with a version control system may have a type of “version control system”.

A possible characteristic of the plurality of operators is that each real-life operator is represented only once on a platform, and thus there may be a constraint that there not be edges within a sub-graph.

Another possible characteristic of the plurality of operators is that separate operators on one platform should be separate operators on another platform. Thus, there may be a constraint that a node on one sub-graph, having a first type, may have at most one edge to another node in an identified other sub-graph, having a second type, however the node may have an additional edge to an additional node in an additional sub-graph, having a third type.

Another possible characteristic of the plurality of operators is for a developer to use both a version control system and a task management system. Thus, there may be a constraint that every node of a sub-graph having a type of “version control system” has an edge to another node of another sub-graph having a type of “task management system”.

A constraint that every node of a sub-graph having a type of “version control system” has an edge to another node of another sub-graph having a type of “communication platform” may indicated a characteristic that every operator of the system uses a communication platform, for example an instant messaging platform, for communication.

Another constraint may be that an identified constraint is transitive, for example separate nodes of a first sub-graph having a first type should not be indirectly connected to a common node of a second sub-graph having a second type via one or more other nodes of one or more other sub-graphs.

Optionally, identifying the set of matches in 330 is further according to the graph computed in 326. Optionally, processing unit 101 identifies in the graph computed in 326 one or more violations of the one or more constraints. Optionally, identifying the set of matches in 330 is further according to the one or more violations.

In 340, processing unit 101 optionally provides the set of matches to one or more management software objects for the purpose of performing one or more management tasks of the one or more projects. For example, a management task may be identifying a late development task and additionally or alternatively identifying a cause of a late development task, for example when a developer assigned to the development task is active in bug fixes or is on vacation. Other examples of a management task include identifying a developer workload and identifying a code area, for example a code area having an increase in an amount of changes and additionally or alternatively an increase in defect reports associated therewith. A code area may be a file or part of a file, for example a function or a part of a function. A code area may be a group of files, for example a component. Optionally, at least some of the one or more management software objects are executed by processing unit 101. Optionally, at least some other of the one or more management software objects are executed by yet another hardware processor.

Optionally, identifying the set of matches in 330 comprises processing unit 101 providing a signature value of a first operator, for example signature 32, and another signature of another operator, for example signature 33, to one or more machine learning models trained to classify a match between at least two operators according to at least two signature values. Optionally, the one or more machine learning model classifies operator 22 and operator 23 as equivalent.

Training a machine learning model to classify a match between at least two operators according to at least two signature values may be done using one or more match data sets. A match data set may be small, reducing accuracy of the trained machine learning model. For example, construction of a test dataset of some 11,369 key base-names from a dictionary of English surnames is described by Snae. In other works data is used from Yahoo! Shopping and Yahoo! Travel.

A match data set may suffer from poor domain adaptation, where accuracy of a machine learning model trained using a match data set created in one domain is reduced when the machine learning model is applied to data collected in a second domain. For example, accuracy of a machine learning model trained using a match data set created using data collected in a first company having a first company work culture is reduced when applied to other data collected in a second company having a second company work culture. In addition, a match data set may be imbalanced, i.e. a plurality of possible classes is not represented equally in the match data set. Training the machine learning model using an imbalanced match data set reduces accuracy of the machine learning model compared to using a balanced match data set. Additionally, or alternatively, one or more labels associated with the match data set may contain errors, further reducing accuracy of a machine learning model trained therewith.

There is a need to improve accuracy of a machine learning model trained using a match training set. Some methods to improve accuracy of the machine learning model include using methods for coping with domain adaptation, for example Daume H. III., Frustratingly easy domain adaptation., arXiv preprint arXiv:0907.1815, 2009.; methods for transfer learning, for example Pan S. J. and Yang Q., A survey on transfer learning., IEEE Transactions on knowledge and data engineering, 22(10):1345-1359, 2009; and methods for ensemble learning, for example Dietterich T. G. et al., Ensemble learning., The handbook of brain theory and neural networks, 2:110-125, 2002.

Some methods to improve accuracy of the machine learning model include using methods for reducing effects of imbalance. Some methods to reduce effects of imbalance are described by Oak et al., by Krawczyk, and by Van Hulse et al. Optionally, to reduce effects of imbalance, processing unit 101 removes from a match data set one or more pairs of signature values where each pair is associated with two operators having a high likelihood of being different, i.e. a likelihood exceeding an identified likelihood threshold. Processing unit 101 may compute a high precision model for non-matching signature values, for example according to names associated with the signature values being significantly different, and may use the high precision model to identify the one or more pairs of signature values.

In some embodiments data used for training the one or more machine learning models is limited, based on basic rules and some human annotation. To increase accuracy, the one or more machine learning models may be trained using labeling function consistency as the optimization problem of the training, for example a labeling function consistency as described in U.S. patent application US20190164086A1, 2017, Amit et al., Framework for semi-supervised learning when no labeled data is given. Optionally, a subset of the plurality of descriptors is sampled and a plurality of sample matches are identified. Optionally, a plurality of classification likelihoods are computed according to the plurality of sample matches. Optionally, estimated probabilities are corrected using maximum likelihood estimation, for example as described in Amit I. and Feitelson D. G., The corrective commit probability code quality metric, 2020.

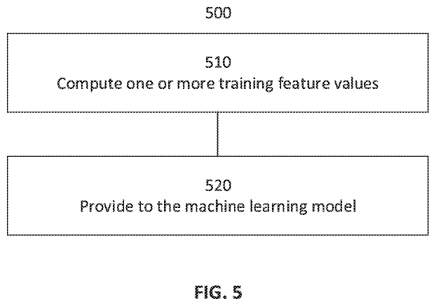

In some embodiments, to increase accuracy of a trained machine learning model, the plurality of descriptors is used when training the one or more machine learning models. Reference is now made also to FIG. 5, showing a flowchart schematically representing an optional flow of operations 500 for training, according to some embodiments. In such embodiments, in 510 processing unit 101 computes one or more training feature values. Optionally, each of the one or more training feature values is indicative of a characteristic of the plurality of entity descriptors. Optionally, each of the one or more training feature values is computed according to the plurality of entity descriptors. Optionally, processing unit 101 executes method 400 to compute the one or more training features.

In 520, processing unit 101 optionally provides the one or more training feature values to the one or more machine learning models, for example during at least some of a plurality of training iterations. Optionally, the plurality of training iterations comprises at least some supervised training iterations. Optionally, the plurality of training iterations comprises at least some unsupervised training iterations.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant software development platforms will be developed and the scope of the term software development platform is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment may include a plurality of “optional” features unless such features conflict.

Throughout this application, various embodiments may be presented in a range format. It should be understood that the description in range format is merely for convenience and brevity and should not be construed as an inflexible limitation on the scope of embodiments. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of embodiments, which are, for clarity, described in the context of separate embodiments, may also be provided in combination in a single embodiment. Conversely, various features of embodiments, which are, for brevity, described in the context of a single embodiment, may also be provided separately or in any suitable subcombination or as suitable in any other described embodiment. Certain features described in the context of various embodiments are not to be considered essential features of those embodiments, unless the embodiment is inoperative without those elements.

Although embodiments have been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method for managing code development, comprising:
accessing at least one software code project on one or more software development platforms;
computing a plurality of signature values, each signature value computed for one of a plurality of operators of the at least one software code project according to a plurality of entries associated with the operator in one of the one or more software development platforms and indicative of a plurality of software development characteristics of the operator;
identifying a set of matches in the plurality of operators, each match identified between at least two of the plurality of operators according to the plurality of signature values; and
providing the set of matches to at least one management software object for the purpose of performing at least one management task of the at least one code project.

2. The method of claim 1, wherein identifying the set of matches comprises:
providing a signature value of a first operator and another signature value of a second operator to at least one machine learning model trained to classify a match between at least two operators according to at least two signature values; and
classifying the first operator and the second operator as a pair of equivalent operators by the at least one machine learning model.

3. The method of claim 1, wherein at least one of the plurality of operators is a developer; and
wherein the respective signature value computed for the developer comprises a plurality of code style statistical values, each indicative of a characteristic of code development style of the developer.

4. The method of claim 3, wherein at least one of the plurality of code style statistical values is selected from the group of code style statistical values consisting of: an amount of characters in a committed code segment, an area identifier indicative of a functional area of a plurality of functional areas of a software code project, a file identifier indicative of a file of the software code project, and an amount of coding errors.

5. The method of claim 1, wherein the operator is a human operator or a computerized agent.

6. The method of claim 1, wherein for at least one other operator of the plurality of operators the respective signature value computed for the other operator comprises one or more personal detail values thereof.

7. The method of claim 6, wherein at least one of the one or more personal detail values is selected from the group of personal detail values consisting of: a first name, a last name, a nickname, a date of birth, an electronic mail address, a username, a home address, a commit date, an employment date, a roll identifier, and an image.

8. The method of claim 1, wherein each operator of the plurality of operators is described by one of a plurality of entity descriptors;
wherein the method further comprises adding to at least one of the plurality of entity descriptors at least one additional personal detail value retrieved from at least one additional platform; and
wherein the respective signature value computed for the respective operator described by the at least one entity descriptor is further according to the at least one additional personal detail value.

9. The method of claim 1, wherein each operator of the plurality of operators is described by one of a plurality of entity descriptors;
wherein the method further comprises computing at least one feature value, each indicative of a characteristic of the plurality of entity descriptors and computed according to the plurality of entity descriptors; and
wherein identifying the set of matches is further according to the at least one feature value.

10. The method of claim 9, wherein computing the at least one feature value comprises at least one of:
identifying at least one dissociated pair of operators of the plurality of operators according to the plurality of signature values;
computing a plurality of nickname associations using the plurality of entity descriptors; and
computing a distance between at least two names, each described by one of the plurality of entity descriptors.

11. The method of claim 1, wherein at least one of the one or more software development platforms is selected from a group of software development platforms consisting of: a task management system, a code management system, and a defect tracking system.

12. The method of claim 1, wherein for at least one yet other operator of the plurality of operators the respective signature value computed for the yet other operator comprises a plurality of text style signature values each computed according to a plurality of textual entries added to the one or more software development platforms thereby.

13. The method of claim 1, further comprising computing a graph, indicative of a plurality of matches between the plurality of operators;
wherein identifying the set of matches is further according to the graph.

14. The method of claim 1, wherein the at least one management task is selected from a group of management tasks consisting of: identifying a code area, identifying a developer workload, and identifying a late development task.

15. The method of claim 2, wherein each operator of the plurality of operators is described by one of a plurality of entity descriptors; and
wherein training the at least one machine learning model comprises:
computing at least one training feature value, each indicative of a characteristic of the plurality of entity descriptors and computed according to the plurality of entity descriptors; and
providing to the machine learning model the at least one training feature value with the plurality of entity descriptors.

16. The method of claim 15, wherein computing the at least one training feature value comprises at least one of:
identifying at least one dissociated pair of operators of the plurality of operators according to the plurality of signature values;
computing a plurality of nickname associations using the plurality of entity descriptors; and
computing a distance between at least two names, each described by one of the plurality of entity descriptors.

17. A system for managing code development, comprising at least one hardware processor adapter for:
accessing at least one software code project on one or more software development platforms;
computing a plurality of signature values, each signature value computed for one of a plurality of operators of the at least one software code project according to a plurality of entries associated with the operator in one of the one or more software development platforms and indicative of a plurality of software development characteristics of the operator;
identifying a set of matches in the plurality of operators, each match identified between at least two of the plurality of operators according to the plurality of signature values; and
providing the set of matches to at least one management software object for the purpose of performing at least one management task of the at least one code project.

18. The system of claim 17, wherein accessing said at least one software code project on said one or more software development platforms is via at least one digital communication network interface connected to said at least one hardware processor.

19. A software program product for managing code development, comprising:
a non-transitory computer readable storage medium;
first program instructions for: accessing at least one software code project on one or more software development platforms;
second program instructions for: computing a plurality of signature values, each signature value computed for one of a plurality of operators of the at least one software code project according to a plurality of entries associated with the operator in one of the one or more software development platforms and indicative of a plurality of software development characteristics of the operator;
third program instructions for: identifying a set of matches in the plurality of operators, each match identified between at least two of the plurality of operators according to the plurality of signature values; and
fourth program instructions for: providing the at least one match to at least one management software object for the purpose of performing at least one management task of the at least one code project;
wherein the first, second, third and fourth program instructions are executed by at least one computerized processor from the non-transitory computer readable storage medium.
